(19) United States
(12) Patent Application Publication
(10) Pub. No.: US 2017/0145951 A1
(43) Pub. Date: May 25, 2017

(54) Textured Piston

(71) Applicant: Caterpillar Inc., Peoria, IL (US)

(72) Inventors: Abhishek Malik, Peoria, IL (US); Brian Applegate, Peoria, IL (US)

(73) Assignee: Caterpillar Inc., Peoria, IL (US)

(21) Appl. No.: 14/945,919

(22) Filed: Nov. 19, 2015

(51) Int. Cl. F02F 3/14; F02F 3/24

(52) U.S. Cl. CPC F02F 3/14; F02F 3/24

(57) ABSTRACT

A piston for an internal combustion engine includes a ring belt extending circumferentially about a longitudinal axis of the piston; a combustion bowl disposed between the longitudinal axis and the ring belt along a radial direction, the radial direction being perpendicular to the longitudinal axis; and a squish face disposed between the combustion bowl and the ring belt along the radial direction. The squish face includes a first textured surface disposed on the squish face, the first textured surface including a first plurality of concave surfaces.

### TECHNICAL FIELD

The present disclosure relates generally to reciprocating internal combustion engines and, more particularly, to a piston for reciprocating internal combustion engines.

### BACKGROUND

Reciprocating combustion engines are known for converting chemical energy from a fuel source into reciprocating or rotating shaft power. In reciprocating engines, fluid is compressed within a cylinder volume defined by a piston, an inner cylinder wall, and a cylinder head, thereby increasing both the pressure and temperature of the fluid. The fluid may include a fuel, an oxidizer such as air, or combinations thereof, for example. In spark ignition engines, fuel and oxidizer are premixed upstream of the cylinder volume or within the cylinder volume, such that ignition of the premixed fuel and oxidizer is initiated by arcing an electrical spark across a gap within the cylinder volume. In compression ignition engines, a fuel-oxidizer mixture within the cylinder volume autoignites in response to a time history of temperature and pressure within the volume. More particularly, in direct injection compression ignition engines, fuel is injected into the cylinder volume near the peak of the compression cycle and ignition of the fuel and oxidizer occurs after an autoignition delay time following injection of the fuel. Heat released from combustion of the fuel-air mixture does work against the piston, which conventionally transfers the work to a rotating crankshaft through a connecting rod.

International Publication No. WO 2007/003817 (“the '817 publication”), entitled “Heat Engine for Motor Vehicle,” purports to address the problem of tailoring the heat release rate within a combustion chamber of a piston engine as a function of time. The '817 publication describes a piston having a concave surface defining a bowl. Further, one or more reliefs are provided on the surface of the bowl, where the one or more reliefs project out or are recessed in relation to a mean surface of the bowl.

However, the reliefs described in the '817 publication may not affect fluid charge motion near the cylinder walls of the combustion chamber as desired in some applications. Accordingly, there is a need for improved pistons for reciprocating internal combustion engines.

It will be appreciated that this background description has been created to aid the reader, and is not a concession that any of the indicated problems were themselves previously known in the art.

### SUMMARY

According to an aspect of the disclosure, a piston for an internal combustion engine includes a ring belt extending circumferentially about a longitudinal axis of the piston; a combustion bowl disposed between the longitudinal axis and the ring belt along a radial direction, the radial direction being perpendicular to the longitudinal axis; and a squish face disposed between the combustion bowl and the ring belt along the radial direction. The squish face includes a first textured surface disposed on the squish face, the first textured surface including a first plurality of concave surfaces.

### BRIEF DESCRIPTION OF THE DRAWINGS

FIG. 1 shows a side view of a piston, according to an aspect of the disclosure.

FIG. 2 shows a top view of a piston, according to an aspect of the disclosure.

FIG. 3 shows a cross sectional schematic view of an engine, according to an aspect of the disclosure.

FIG. 4 shows a schematic cross sectional view of a textured surface, according to an aspect of the disclosure.

FIG. 5 shows a schematic cross sectional view of a textured surface, according to an aspect of the disclosure.

FIG. 6 shows a cross sectional view of the piston indicated as Detail A in FIG. 3, according to an aspect of the disclosure.

FIG. 7 shows a cross sectional view of the piston indicated as Detail A in FIG. 3, according to an aspect of the disclosure.

### DETAILED DESCRIPTION

Aspects of the disclosure will now be described in detail with reference to the drawings, wherein like reference numbers refer to like elements throughout, unless specified otherwise.

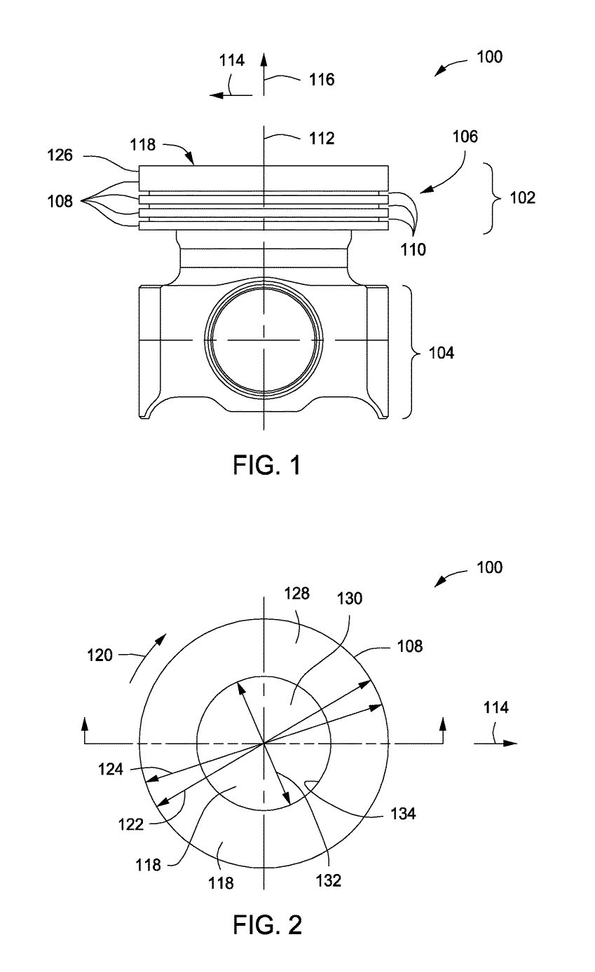

FIG. 1 shows a side view of a piston 100, according to an aspect of the disclosure; and FIG. 2 shows a top view of a piston 100, according to an aspect of the disclosure. The piston 100 includes a crown portion 102 and may include a skirt portion 104. The crown portion 102 defines a circumferential ring belt 106 around a circumferential periphery of the piston 100. The circumferential ring belt 106 may include two or more cylindrical surfaces 108 defining at least one circumferential ring groove 110 therebetween. Each of the circumferential ring grooves 110 may be configured to hold a compression ring, an oil ring, or other piston ring known in the art.

At least one of the cylindrical surfaces 108 is centered about a longitudinal axis 112 of the piston 100. A radial direction 114 of the piston 100 extends perpendicular to the longitudinal axis 112, and a compression direction 116 of the piston 100 extends along the longitudinal axis 112 in a direction away from a top surface 118 of the piston 100. A circumferential direction 120 extends around a periphery of the piston 100 normal to the radial direction 114.

An outer diameter 122 of the piston 100 may be defined by a diameter of one of the cylindrical surfaces 108. However, it will be appreciated that each of the two or more cylindrical surfaces 108 may have a different diameter or the same diameter. An outer diameter 124 of the top surface 118 may be defined by a diameter of an uppermost cylindrical surface 126, relative to the compression direction 116.

The top surface 118 of the piston 100 extends from the longitudinal axis 112 to the outer diameter 124 of the top surface 118. It will be appreciated that the top surface 118 of the piston 100 may include features that extend in the longitudinal direction 112, the radial direction 114, the circumferential direction 120, or combinations thereof, between the longitudinal axis 112 and the outer diameter 124 of the top surface 118.

The top surface 118 of the piston 100 may include a squish face 128 and a combustion bowl surface 130. According to one aspect of the disclosure, at least part of the squish face 128 and at least part of the combustion bowl surface 130 face the compression direction 116. Here, a surface facing the compression direction 116 may mean that a vector normal to the surface has a component in the compression direction 116. According to another aspect of the disclosure, an entirety of the squish face 128 faces in the compression direction 116. For example, an internal diameter 132 of the squish face 128 may be defined by an internal edge 134 of the squish face 128, and an entirety of the squish face 128 extending between the internal diameter 132 and the outer diameter 124 of the top surface 118 may face the compression direction 116.

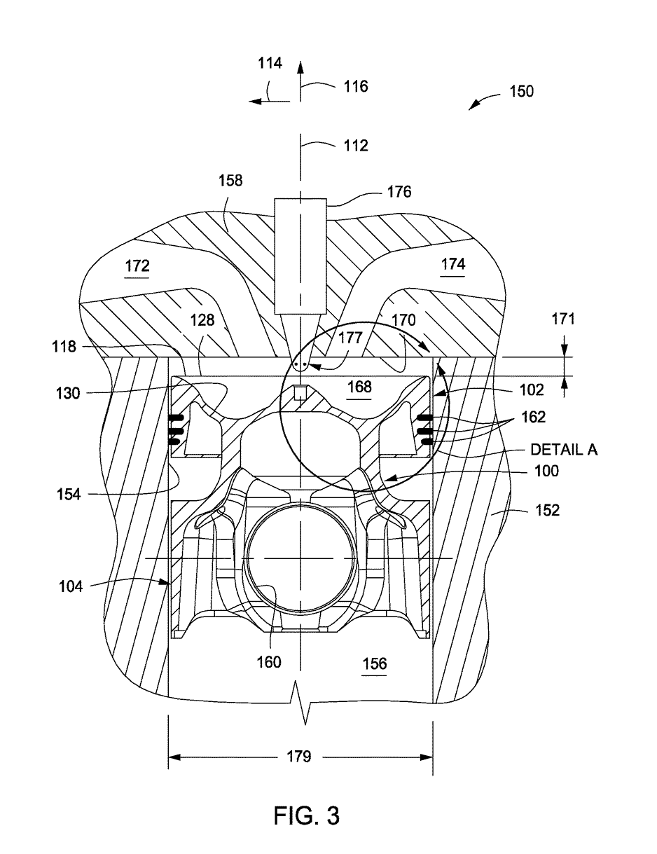

FIG. 3 shows a cross sectional schematic view of an engine 150, according to an aspect of the disclosure, where the section plane includes the longitudinal axis 112. The engine 150 includes an engine cylinder 152 with an inner surface 154 that defines a cylinder bore 156 therethrough, the piston 100 slidably disposed within the cylinder bore 156, and a cylinder head 158 disposed on top of the engine cylinder 152. The piston 100 may be operatively coupled to a crankshaft (not shown) through a connecting rod (not shown), which is pivotally coupled to a pin journal 160 of the piston 100 according to conventional approaches, for example. Further, the piston 100 may engage the inner surface 154 of the of the engine cylinder 152 through one or more rings 162 disposed in one or more ring grooves 110 (see FIG. 1). Although only one engine cylinder 152 is shown in FIG. 3, it will be appreciated that the engine 150 may include any number of engine cylinders 152 greater than or equal to one.

A combustion chamber 168 may be defined by the top surface 118 of the piston 100, including the combustion bowl surface 130 and the squish face 128; a piston ring 162; the inner surface 154 of the engine cylinder 152; and an inner surface 170 of the cylinder head 158. In FIG. 3 the engine 150 is shown configured with the piston 100 located near top dead center (TDC) of a compression stroke in the compression direction 116, such that a distance between the piston 100 and the cylinder head 158 is near a minimum. The piston 100 may also be located within the cylinder bore 156 at bottom dead center (BDC), where a distance between the piston 100 and the cylinder head 158 is near a maximum.

A compression ratio of the engine 150 may be defined as a volume of the combustion chamber 168 when the piston 100 is at BDC divided by a volume of the combustion chamber 168 when the piston 100 is at TDC. According to an aspect of the disclosure, the engine 150 is a compression ignition engine having a compression ratio not less than about 12:1.

The cylinder head 158 may define at least one intake port 172 therethrough, at least one exhaust port 174 therethrough, or combinations thereof, such that an oxidizer or a mixture of oxidizer and fuel may enter the combustion chamber 168 via the at least one intake port 172, and combustion products may exit the combustion chamber 168 via the at least one exhaust port 174. Intake and exhaust valves may selectively block or effect fluid communication between the intake port 172 or the exhaust port 174 and the combustion chamber 168 according to conventional approaches known to persons having ordinary skill in the art, for example. Intake valves and exhaust valves are omitted from FIG. 3 to promote clarity of other features.

According to an aspect of the disclosure, the engine 150 is a direct-injection compression ignition engine, including at least one fuel injector 176 defining at least one fuel injection orifice 177 disposed within the combustion chamber 168. The high-pressure fuel injector 176 may be configured to inject fuel into the combustion chamber 168 near TDC of the compression stroke. Further, the engine 150 may operate based on a four-stroke cycle, a two-stroke cycle, or any other thermodynamic cycle for reciprocating internal combustion engines known to persons having ordinary skill in the art.

According to aspects of the disclosure, any portion of the top surface 118 of the piston 100 may include a textured surface. As described herein, a surface that includes a textured surface may be the result of superimposing a nominal surface with the textured surface, where the nominal surface is substantially smooth and the textured surface includes at least two concave surfaces.

Nominal surfaces may include planar surfaces, frustoconical surfaces, cylindrical surfaces, spherical surfaces, ellipsoidal surfaces, polynomial surfaces, toroidal surfaces, surfaces of revolution, combinations thereof, or any other nominal surface known in the art. As used herein, the term “substantially smooth” means having a roughness typical of conventional machining or other manufacturing process to form the nominal surface. According to an aspect of the disclosure, a substantially smooth surface has a surface roughness that is not greater than 100 micro-inches. According to another aspect of the disclosure, a substantially smooth surface has a surface roughness that is not greater than 20 micro-inches. According to another aspect of the disclosure, a substantially smooth surface is a theoretical surface having no surface roughness.

Textured surfaces may include dimples, bumps, knurling, elongate channels, combinations thereof, or any other textured surface known in the art. Elongate channels of a textured surface may be characterized by a sinusoidal wave form, a saw tooth wave form, a rectangular wave form, a triangular wave form, a scalloped wave form, combinations thereof, or any other wave form known in the art. Furthermore, an elongate channel characterizing a textured surface may be a continuous channel formed by a surface of revolution about an axis.

Superposition of a nominal surface with a textured surface to define the structure of a resulting surface may be achieved through actual or virtual removal of material from the nominal surface, actual or virtual addition of material to the nominal surface, or combinations thereof. However, it will be appreciated that the actual fabrication of a textured surface according to aspects of this disclosure does not necessarily require the fabrication of the nominal surface itself followed by modification of the nominal surface to effect the textured surface. Instead, according to some aspects of the disclosure, the superposition of a nominal surface and a textured surface may be fabricated in the same manufacturing step, including machining, casting, forging, welding, 3-D printing, combinations thereof, or any other fabrication method known in the art.

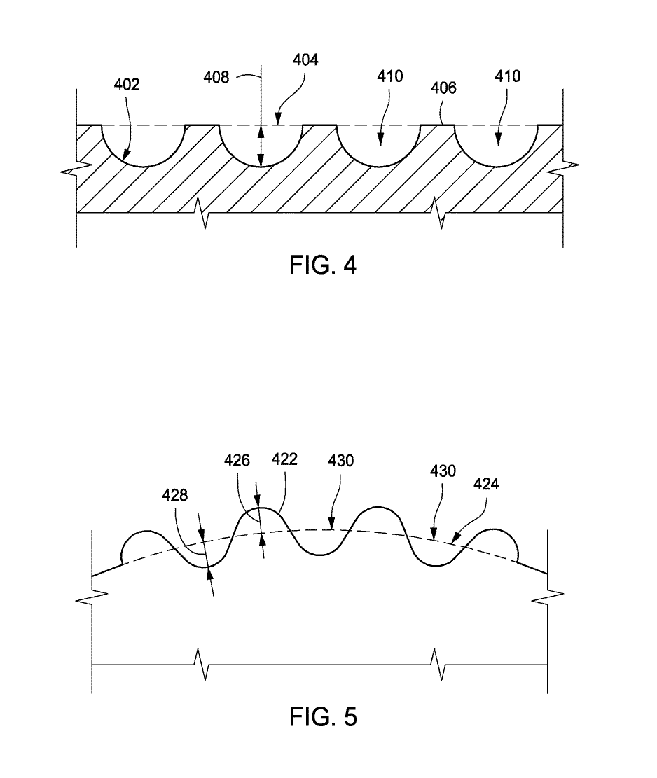

Depth or amplitude of a textured surface may be characterized by the sum of the distance from the nominal surface to a peak of the textured surface and the distance from the nominal surface to a trough of the textured surface. For example, as illustrated in FIG. 4, a dimple-textured surface 402 is superimposed on a nominal planar surface 404, according to an aspect of the disclosure. In this particular example, the nominal planar surface 404 is coincident with peaks 406 of the dimple-textured surface 402. Further, the troughs of the dimple-textured surface 402 are separated from the nominal planar surface 404 by a distance 408, which is evaluated normal to the nominal planar surface 404. Thus, in the specific example illustrated in FIG. 4, the depth or amplitude of the textured surface is the distance 408. Further, FIG. 4 illustrates an example of superimposing a textured surface onto a nominal surface by removing material from the nominal surface.

It will be appreciated that the dimple-textured surface 402 includes at least two concavities 410. As illustrated in FIG. 4, the dimple-textured surface 402 includes at least four concavities. FIG. 4 is a non-limiting example of a textured surface that includes at least two concave surfaces but does not include any convex surfaces.

As illustrated in FIG. 5, a sinusoid-textured surface 422 is superimposed on a nominal cylindrical surface 424, according to an aspect of the disclosure. In FIG. 5, peaks of the sinusoid-textured surface 422 are separated from the nominal cylindrical surface 424 by a first distance 426, and troughs of the sinusoid-textured surface 422 are separated from the nominal cylindrical surface 424 by a second distance 428. Thus, in the specific example illustrated in FIG. 5, the depth or amplitude of the textured surface is the sum of the first distance 426 and the second distance 428, where each of the first distance 426 and the second distance 428 are evaluated normal to the nominal cylindrical surface 424. Furthermore, FIG. 5 illustrates an example of superimposing a textured surface onto a nominal surface by both removing material from the nominal surface and adding material to the nominal surface.

The sinusoid-textured surface 422 includes at least two concavities 430. As illustrated in FIG. 5, the sinusoid-textured surface 422 includes at least three concavities. FIG. 5 is a non-limiting example of a textured surface that includes both concave and convex surfaces.

According to an aspect of the disclosure, a textured surface has a depth or amplitude that is greater than or equal to 0.001 inches. According to another aspect of the disclosure, a textured surface has a depth or amplitude that is greater than or equal to 0.01 inches. According to another aspect of the disclosure, a textured surface has a depth or amplitude that is greater than a surface roughness of the nominal surface onto which the textured surface is superimposed.

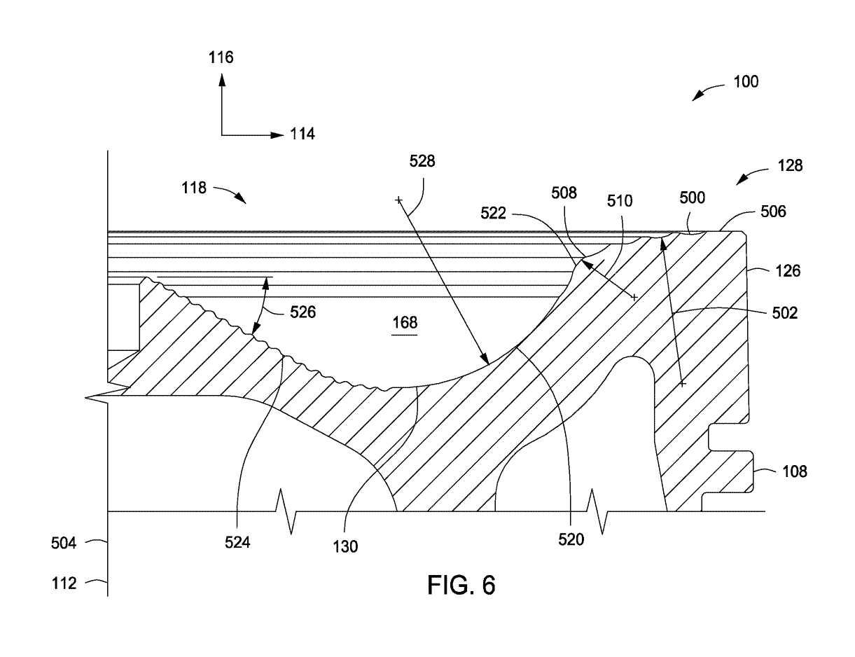

FIG. 6 shows a detailed section view of a piston 100, as indicated by Detail A in FIG. 3, according to an aspect of the disclosure. Similar to the piston 100 illustrated in FIGS. 1 and 2, the piston 100 illustrated in FIG. 6 has an upper surface 118 including a combustion bowl surface 130 and a squish face 128, where the combustion bowl surface 130 is disposed between the squish face 128 and the longitudinal axis 112 along the radial direction 114. However, the squish face 128 in FIG. 6 includes a first squish surface 500 defined by superposition of a first nominal surface and a first textured surface.

The nominal surface of the first squish surface 500 may be a toroidal surface defined by a section radius 502 and an axis of revolution 504, such that the first squish surface 500 has a convex profile with respect to the compression direction 116 in a plane defined by the compression direction 116 and the radial direction 114. According to an aspect of the disclosure, the axis of revolution 504 is coaxial with the longitudinal axis 112, however it will be appreciated that the axis of revolution 504 need not be coaxial with the longitudinal axis 112. Alternatively, the nominal surface of the first squish surface 500 may be a frustoconical surface of revolution about the axis of revolution 504, such that the nominal surface of the first squish surface 500 is neither convex nor concave with respect to the compression direction 116 in a plane defined by the compression direction 116 and the radial direction 114.

The first textured surface may be defined by a surface of revolution including a wave profile in a plane including the compression direction 116 and the radial direction 114. A wave profile of the first textured surface may be characterized by a sinusoidal profile or a scalloped profile, for example. Alternatively or additionally, the first textured surface may be characterized by dimples.

The squish face 128 may include a second squish surface 506 that is disposed between the first squish surface 500 and the uppermost cylindrical surface 126 along the radial direction 114. The second squish surface 506 may be an annular planar surface or a frustoconical surface of revolution about the axis of revolution 504. The second squish surface 506 may adjoin the uppermost cylindrical surface 126. Alternatively or additionally, the second squish surface 506 may adjoin the first squish surface 500. According to an aspect of the disclosure, the second squish surface 506 may be substantially smooth and therefore not include a textured surface.

The squish face 128 may include a third squish surface 508 that is disposed between the first squish surface 500 and the combustion bowl surface 130 along the radial direction 114. The third squish surface 508 may be a toroidal surface defined by a section radius 510 and the axis of revolution 504, such that the third squish surface 508 has a convex profile with respect to the compression direction 116 in a plane defined by the compression direction 116 and the radial direction 114. According to an aspect of the disclosure, the section radius 510 of the third squish surface 508 is less than the section radius 502 of the first squish surface 500.

The third squish surface 508 may adjoin the first squish surface 500. Alternatively or additionally, the third squish surface 508 may adjoin a concave bowl surface 520 of the combustion bowl surface 130. Accordingly, the third squish surface 508 may define an inflection point 522 in transition between the nominally convex profile of the first squish surface 500 and the nominally concave profile of the concave bowl surface 520, with respect to the compression direction 116 in a plane defined by the compression direction 116 and the radial direction 114. According to an aspect of the disclosure, the inflection point 522 defines the inner radial boundary of the squish face 128 and the outer radial boundary of the combustion bowl surface 130.

Referring still to FIG. 6, the combustion bowl surface 130 includes a first bowl surface 524 extending away from the compression direction 116 as the first bowl surface 524 extends radially away from the longitudinal axis 112. As illustrated in FIG. 6, the first bowl surface 524 may be defined by a superposition of a nominal frustoconical surface and a second textured surface. The nominal frustoconical surface may form an angle 526 with the radial direction 114 that is less than 90 degrees. According to an aspect of the disclosure, the angle 526 is not greater than 45 degrees. The second textured surface may be defined by a surface of revolution having a sinusoidal profile, a scalloped profile, or any other periodic surface profile known in the art. Alternatively or additionally, the second textured surface may be characterized by dimples.

The combustion bowl surface 130 also include the concave bowl surface 520 disposed between the first bowl surface 524 and the squish face 128 along the radial direction 114. The concave bowl surface 520 may be defined by a superposition of a nominal toroidal surface and a third textured surface. The nominal toroidal surface of the concave bowl surface 520 may be characterized by the section radius 528 and the axis of revolution 504.

According to an aspect of the disclosure, a texturing profile of the first bowl surface 524 may extend across a portion of the radially innermost part of the concave bowl surface 520. Alternatively or additionally, a portion of the radially outermost part of the concave bowl surface 520 may include a textured surface. According to another aspect of the disclosure, a radially central portion of the concave bowl surface 520, located between the radially innermost portion and the radially outermost portion of the concave bowl surface 520, may be substantially smooth and therefore free from a textured surface.

The texture of the concave bowl surface 520 may be defined by a surface of revolution having a sinusoidal profile, a scalloped profile, or any other periodic surface profile known in the art. Alternatively or additionally, the texture of the concave bowl surface 520 may be characterized by dimples. According to an aspect of the disclosure, the section radius 528 of the concave bowl surface 520 is greater than the section radius 510 of the third squish surface 508.

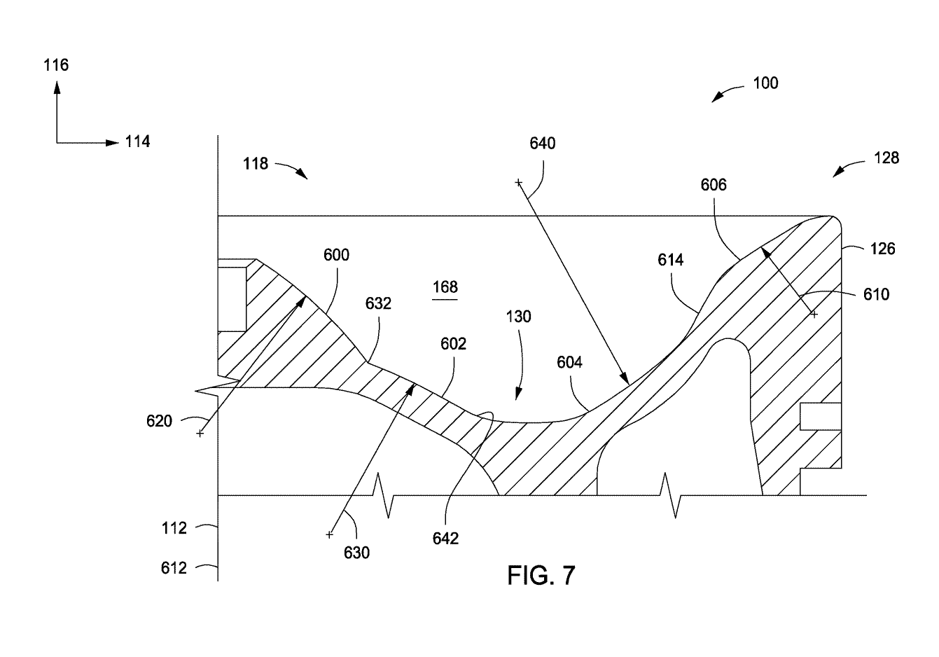

FIG. 7 shows a detailed section view of a piston 100, as indicated by Detail A in FIG. 3, according to an aspect of the disclosure.

Similar to the piston 100 illustrated in FIGS. 1 and 2, the piston 100 illustrated in FIG. 7 has an upper surface 118 including a combustion bowl surface 130 and a squish face 128, where the combustion bowl surface 130 is disposed between the squish face 128 and the longitudinal axis 112 along the radial direction 114. However, the combustion bowl surface 130 in FIG. 7 includes a first bowl surface 600, a second bowl surface 602, and a third bowl surface 604, and the squish face 128 includes a first squish surface 606.

The first squish surface 606 is located between the longitudinal axis 112 and the uppermost cylindrical surface 126 along the radial direction 114. According to an aspect of the disclosure, the first squish surface 606 adjoins the uppermost cylindrical surface 126. Alternatively or additionally, the first squish surface 606 may adjoin the combustion bowl surface 130.

The structure of first squish surface 606 may be defined by a superposition of a first nominal toroidal surface and a first textured surface, and may be referred to as “a chamfius.” The first nominal toroidal surface may be defined by a section radius 610 and an axis of revolution 612. Although the axis of revolution 612 may be coaxial with the longitudinal axis 112, it will be appreciated that the axis of revolution 612 need not be coaxial with the longitudinal axis 112. The first nominal toroidal surface is convex with respect to the compression direction 116 in a plane defined by the compression direction 116 and the radial direction 114.

The first textured surface of the first squish surface 606 may be defined by a surface of revolution including a wave profile in a plane including the compression direction 116 and the radial direction 114. A wave profile of the first textured surface may be characterized by a sinusoidal profile or a scalloped profile, for example. Alternatively or additionally, the first textured surface may be characterized by dimples.

According to an aspect of the disclosure, a depth or amplitude of the texture of the first squish surface 606 may range from about 0.003 times the section radius 610 to about 0.009 times the section radius 610. According to another aspect of the disclosure, a depth or amplitude of the texture of the first squish surface 606 may range from about 0.005 times the section radius 610 to about 0.007 times the section radius 610.

According to an aspect of the disclosure, a wavelength of the texture of the first squish surface 606 may range from about 0.2 times the section radius 610 to about 0.4 times the section radius 610. According to another aspect of the disclosure, a wavelength of the texture of the first squish surface 606 may range from about 0.30 times the section radius 610 to about 0.34 times the section radius 610.

The first squish surface 606 may adjoin the third bowl surface 604, which has a concave profile relative to the compression direction 116 in a plane including the compression direction 116 and the radial direction 114. Accordingly, the first squish surface 606 may adjoin the third bowl surface 604 at an inflection point 614 where the convexity of the first squish surface 606 transitions to the concavity of the third bowl surface 604. Further, the squish face 128 may be defined as lying between the inflection point 614 and the uppermost cylindrical surface 126 along the radial direction 114.

The first bowl surface 600 is located between the longitudinal axis 112 and the squish face 128 along the radial direction 114. The structure of first bowl surface 600 may be defined by a superposition of a second nominal toroidal surface and a second textured surface. The second nominal toroidal surface may be defined by a section radius 620 and an axis of revolution 612. According to an aspect of the disclosure, the second nominal toroidal surface is convex with respect to the compression direction 116 in a plane that includes the compression direction 116 and the radial direction 114.

The second textured surface of the first bowl surface 600 may be defined by a surface of revolution including a wave profile in a plane including the compression direction 116 and the radial direction 114. A wave profile of the second textured surface may be characterized by a sinusoidal profile or a scalloped profile, for example. Alternatively or additionally, the second textured surface may be characterized by dimples.

According to an aspect of the disclosure, a depth or amplitude of the texture of the first bowl surface 600 may range from about 0.0008 times the section radius 620 to about 0.0012 times the section radius 620. According to another aspect of the disclosure, a depth or amplitude of the texture of the first bowl surface 600 is about 0.001 times the section radius 620.

According to an aspect of the disclosure, a wavelength of the texture of the first bowl surface 600 may range from about 0.01 times the section radius 620 to about 0.1 times the section radius 620. According to another aspect of the disclosure, a wavelength of the texture of the first bowl surface 600 may range from about 0.02 times the section radius 620 to about 0.08 times the section radius 620.

The second bowl surface 602 is located between the first bowl surface 600 and the squish face 128 along the radial direction 114. The structure of second bowl surface 602 may be defined by a superposition of a third nominal toroidal surface and a third textured surface. The third nominal toroidal surface may be defined by a section radius 630 and an axis of revolution 612. According to an aspect of the disclosure, the third nominal toroidal surface is convex with respect to the compression direction 116 in a plane that includes the compression direction 116 and the radial direction 114. Alternatively, the structure of the second bowl surface 602 may be defined by a superposition of a nominally frustoconical surface and the third textured surface.

The third textured surface of the second bowl surface 602 may be defined by a surface of revolution including a wave profile in a plane including the compression direction 116 and the radial direction 114. A wave profile of the third textured surface may be characterized by a sinusoidal profile or a scalloped profile, for example. Alternatively or additionally, the third textured surface may be characterized by dimples.

According to an aspect of the disclosure, a depth or amplitude of the texture of the second bowl surface 602 may range from about 0.0008 times the section radius 630 to about 0.0012 times the section radius 630. According to another aspect of the disclosure, a depth or amplitude of the texture of the second bowl surface 602 is about 0.001 times the section radius 630.

According to an aspect of the disclosure, a wavelength of the texture of the second bowl surface 602 may range from about 0.01 times the section radius 630 to about 0.1 times the section radius 630. According to another aspect of the disclosure, a wavelength of the texture of the second bowl surface 602 may range from about 0.02 times the section radius 630 to about 0.08 times the section radius 630.

The second bowl surface 602 may adjoin the first bowl surface 600. Further, the second bowl surface 602 may adjoin the first bowl surface 600 at a cusp 632 because both the second bowl surface 602 and the first bowl surface 600 are convex with respect to the compression direction 116 in a plane that includes the compression direction 116 and the radial direction 114.

The third bowl surface 604 is located between the second bowl surface 602 and the squish face 128 along the radial direction 114. The structure of third bowl surface 604 may be defined by a superposition of a fourth nominal toroidal surface and a fourth textured surface. The fourth nominal toroidal surface may be defined by a section radius 640 and an axis of revolution 612. According to an aspect of the disclosure, the fourth nominal toroidal surface is concave with respect to the compression direction 116 in a plane that includes the compression direction 116 and the radial direction 114.

The fourth textured surface of the third bowl surface 604 may be defined by a surface of revolution including a wave profile in a plane including the compression direction 116 and the radial direction 114. A wave profile of the fourth textured surface may be characterized by a sinusoidal profile or a scalloped profile, for example. Alternatively or additionally, the fourth textured surface may be characterized by dimples.

According to an aspect of the disclosure, a depth or amplitude of the texture of the third bowl surface 604 may range from about 0.003 times the section radius 640 to about 0.009 times the section radius 640. According to another aspect of the disclosure, a depth or amplitude of the texture of the third bowl surface 604 may range from about 0.005 times the section radius 640 to about 0.007 times the section radius 640.

According to an aspect of the disclosure, a wavelength of the texture of the third bowl surface 604 may range from about 0.2 times the section radius 640 to about 0.4 times the section radius 640. According to another aspect of the disclosure, a wavelength of the texture of the third bowl surface 604 may range from about 0.30 times the section radius 640 to about 0.34 times the section radius 640.

The third bowl surface 604 may adjoin the second bowl surface 602. Further, the third bowl surface 604 may adjoin the second bowl surface 602 at an inflection point 642 where the convexity of the second bowl surface 602 transitions to the concavity of the third bowl surface 604.

Any surfaces of revolution described herein may extend completely, or 360 degrees, about their respective axes of revolution. However, it will be appreciated that a surface of revolution need not extend completely about its respective axis of revolution to be considered a surface of revolution as contemplated herein.

Any periodic wave or profile described herein may have a constant amplitude, a constant wavelength, or both constant amplitude and constant wavelength throughout. However, it will be appreciated that the amplitude, the wavelength, or both, of a textured surface may vary across the textured surface and still be considered a periodic wave or profile as contemplated herein.

### INDUSTRIAL APPLICABILITY

The present disclosure is generally applicable to reciprocating internal combustion engines and more particularly applicable to pistons for reciprocating internal combustion engines.

It will be appreciated that an engine 150 including the piston 100 may be incorporated into a machine to provide mechanical power for operating the machine. The machine can be an over-the-road vehicle, such as a truck used in transportation, or may be any other type of machine that performs an operation associated with an industry such as mining, construction, farming, transportation, forestry, or any other industry known in the art. For example, the machine may be an off-highway truck; an on-highway truck; a locomotive; a maritime machine; an earth-moving machine, such as a wheel loader, an excavator, a dump truck, a backhoe, or a motor grader; a material handler; a feller-buncher; or the like. The term “machine” can also refer to stationary equipment, such as a generator that is driven by an internal combustion engine to generate electricity.

The shape of the top surface 118 of a piston 100 may be designed to reduce emissions, increase part life, promote operability, promote performance, reduce cost, or combinations thereof. In particular, different portions of the top surface 118 of a piston 100 may be designed to promote a set of metrics unique to that portion of the piston, at least in part because different portions of the piston contain fluid in different stages of mixing and/or reaction progress.

For example, along the radially inner portions of the combustion bowl surface 130, designers may shape the combustion bowl surface 130 to promote mixing between fuel jets from the fuel injector 176 and an oxidizer without direct impingement of the fuel jets onto the radially inner portions of the combustion bowl surface 130, and largely unaided by chemical reactions between oxidizer and the injected fuel. However, along radially outer portions of the combustion bowl surface 130 and along the squish face 128 substantial chemical reactions take place and designers may wish to steer the reacting fluid to effect specific fluid charge motion within the combustion chamber 168 instead of enhancing pure jet mixing. Specifically, designers may target a specific interaction between the reacting jets of fuel and the inner surface 154 of the cylinder bore 156 to control particulate emissions, for example.

Piston structures to effect the desired charge motion within the outer radial regions of the combustion chamber 168 may be limited by piston weight, cylinder head 158 design, heat transfer within the piston 100, material thickness of piston structural features, target piston 100 life, target compression ratios, combinations thereof, and any other piston design constraint known in the art. Accordingly, applicants sought new degrees of freedom for piston structural design to better tailor fluid charge motion with in the combustion chamber 168 to promote certain metrics while satisfying other practical design constraints. As a result, applicants discovered that by adding texturing features to nominal piston surface shapes, the textured piston designs could better achieve fluid charge motion objectives, within other design constraints, in ways that piston designs with substantially smooth surfaces could not provide.

In one non-limiting application, applicants discovered piston surface designs for the squish face 128, and optionally radially outer portions of the combustion bowl surface 130, by using the superposition of nominal smooth surfaces with textured surfaces to advantageously inhibit separation of flow from the piston top surface 118 in transition from the radially outer portions of the combustion bowl surface 130 to the squish face 128. As a result, applicants discovered textured piston surface designs that could better control particulate emissions while simultaneously meeting other design constraints.

In addition, applicants discovered piston surface designs for the radially inner portions of the combustion bowl surface 130 using the superposition of nominal smooth surfaces with textured surfaces to better control emissions of oxides of nitrogen (NOx). As jets of fuel flow past the inner radial portions of the combustion bowl surface 130, mixtures of fuel and oxidizer are formed near the interface between the liquid fuel jets and the oxidizer. In turn, applicants discovered that adding texture to the radially inner portions of the combustion bowl surface 130 could advantageously enhance mixing before autoignition of the fuel-oxidizer mixture, thereby reducing NOx generation by reducing the flame temperature resulting from autoignition of the fuel-oxidizer mixture and promoting clean burning of subsequent diffusion mode combustion.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein.

We claim:

1. A piston for an internal combustion engine, the piston comprising:
a ring belt extending circumferentially about a longitudinal axis of the piston;
a combustion bowl disposed between the longitudinal axis and the ring belt along a radial direction, the radial direction being perpendicular to the longitudinal axis; and
a squish face disposed between the combustion bowl and the ring belt along the radial direction,
the squish face including a first textured surface disposed on the squish face, the first textured surface including a first plurality of concave surfaces.

2. The piston of claim 1, wherein the combustion bowl includes a second textured surface, the second textured surface including a second plurality of concave surfaces.

3. The piston of claim 2, wherein the combustion bowl includes a frustoconical surface that is centered on the longitudinal axis, and the frustoconical surface includes the second textured surface.

4. The piston of claim 3, wherein the combustion bowl includes a concave toroidal surface disposed between the frustoconical surface and the squish face along the radial direction.

5. The piston of claim 1, wherein the first textured surface is defined by a first surface of revolution that is centered on the longitudinal axis.

6. The piston of claim 1, wherein the first textured surface further includes a first plurality of convex surfaces.

7. The piston of claim 6, wherein at least one concave surface of the first plurality of concave surfaces is disposed between adjacent convex surfaces of the first plurality of convex surfaces.

8. The piston of claim 7, wherein the first plurality of concave surfaces and the first plurality of convex surfaces are defined by a first surface of revolution that is centered on the longitudinal axis.

9. The piston of claim 8, wherein the first plurality of concave surfaces is interlaced with the first plurality of convex surfaces.

10. The piston of claim 9, wherein each concave surface of the first plurality of concave surfaces has a sinusoidal profile in a plane including the longitudinal axis, and each convex surface of the first plurality of convex surfaces has a sinusoidal profile in the plane including the longitudinal axis.

11. The piston of claim 2, wherein the combustion bowl includes a convex toroidal surface that is centered on the longitudinal axis, and the convex toroidal surface includes the second textured surface.

12. The piston of claim 1, wherein the squish face includes a convex toroidal surface that is centered on the longitudinal axis, and the convex toroidal surface includes the first textured surface.

13. The piston of claim 12, wherein the convex toroidal surface is defined by a radius of curvature and a radius of revolution about the longitudinal axis, and
wherein a depth of each concave surface of the first plurality of concave surfaces is not less than 0.002 times the radius of curvature and not greater than 0.014 times the radius of curvature.

14. The piston of claim 13, wherein a spacing of each concave surface of the first plurality of concave surfaces with an adjacent concave surface of the first plurality of concave surfaces is defined by a wavelength, and the wavelength ranges from about 0.2 times the radius of curvature to about 0.4 times the radius of curvature.

15. The piston of claim 4, wherein the concave toroidal surface is substantially free from a superimposed texture, such that a surface finish amplitude of the concave toroidal surface is less than 100 micro-inches.

16. The piston of claim 1, wherein the squish face adjoins the combustion bowl at an inflection point where a convexity of the squish face transitions to a concavity of the combustion bowl.

17. The piston of claim 1, wherein the first textured surface includes a surface of revolution having a scalloped profile in a plane that includes the longitudinal axis.

18. The piston of claim 1, wherein the first textured surface adjoins the combustion bowl.

19. A reciprocating internal combustion engine including the piston of claim 1.

20. A machine including the reciprocating internal combustion engine of claim 19.
